(19) United States
(12) Patent Application Publication
(10) Pub. No.: US 2024/0270209 A1
(43) Pub. Date: Aug. 15, 2024

(54) WIPER DEVICE

(71) Applicant: Robert Bosch GmbH, Stuttgart (DE)

(72) Inventors: Andrija Terentic, Belgrad (RS); llija Pjescic, Belgrad (RS)

(21) Appl. No.: 18/567,957

(22) PCT Filed: Jun. 21, 2021
(86) PCT No.: PCT/EP2021/066812

§ 371 Date: Dec. 7, 2023

(51) Int. Cl. B60S 1/34; B60S 1/38

(52) U.S. Cl. CPC B60S 1/3415; B60S 1/3862

(57) ABSTRACT

The invention relates to a wiper device with at least one fluid feed unit (10) comprising a fluid supply line (12) and a fluid connection element (14), the fluid connection element (14) being provided with a main fluid channel (28) that runs into the fluid supply line (12) and is connected to at least one secondary fluid channel (16) that also runs into the fluid supply line (12). It is proposed that a sealing means (18) cooperate with an area at one end (19) of the fluid supply line (12) such that an opening (15) in the fluid supply line (12) and the secondary fluid channel (16) are sealingly arranged within the fluid supply line (12).

### BACKGROUND

A wiper device with at least one fluid connection element and with at least one fluid feed unit, which is provided for at least sectional fluid transport along a wiper arm, and which has at least one fluid supply line which is fluidically connected to the at least one fluid connection element, has already been proposed.

### SUMMARY

The invention starts from a wiper device with at least one fluid connection element and with at least one fluid feed unit, which is provided for at least sectional fluid transport along a wiper arm, and which has at least one fluid supply line which is fluidically connected to the at least one fluid connection element.

It is proposed that the at least one fluid connection element with the at least one fluid supply line form at least one check valve, in particular Dunlop valve.

A “wiper device” is preferably intended to be understood to mean at least a part, preferably a subassembly, of a windshield wiper. The wiper device can preferably also comprise the entire windshield wiper, in particular with a wiper blade. The wiper device is preferably provided for use on a vehicle. The wiper device, preferably as part of the windshield wiper, is preferably provided for cleaning a surface, preferably a windshield on a vehicle. Preferably, the wiper device is coupled to a vehicle, in preferably a wiper arm of a vehicle, for cleaning a vehicle windshield. “Provided” is preferably to be understood as meaning specifically configured, specifically designed and/or specifically equipped. An object being provided for a specific function is preferably to be understood to mean that the object fulfils and/or carries out this specific function in at least one application and/or operating state. An “operating state” is preferably intended to be understood to mean a state in which the wiper device is ready for a wiping process and/or a wiping operation and/or is coupled at least to a wiper arm and/or a wiper blade and/or is in a wiping operation in which a wiper strip unit of the wiper device, in particular the windshield wiper, is preferably guided over a vehicle windshield and thereby advantageously bears against the vehicle windshield.

The fluid feed unit comprises a fluid supply line and a fluid connection element, wherein the fluid connection element has a main fluid channel that opens into the fluid supply line. In particular, the fluid connection element is tubular. Furthermore, at least one secondary fluid channel is connected to the main fluid channel, which also opens into the fluid supply line. A sealing means cooperates with a portion at an end of the fluid supply line so that an orifice of the fluid supply line and the secondary fluid channel are sealingly arranged within the fluid supply line. The sealing means seals the fluid supply line so that no fluid leaks through the end of the fluid supply line. The area at the end represents a part of the fluid supply line that rests on fluid connection element.

Preferably, the fluid feed unit comprises a fluid supply line extending along a longitudinal axis of the wiper arm over at least 80%, preferably over at least 90%, of the wiper arm, preferably to a fluid supply of a wiper blade. A “longitudinal axis” of an object preferably is to be understood as an axis which runs parallel to a longest edge of a smallest imaginary cuboid which just completely encloses the object. Preferably, the fluid supply line is designed as at least one hose. For example, the fluid supply line can be designed as at least two hoses running parallel to each other. The fluid supply line can be designed as several fluidically connected hoses. Preferably, the fluid supply line is made of an elastically deformable material. Preferably, at least one end piece of the at least one fluid supply line is formed from an elastically deformable material. For example, the at least one fluid supply line can be formed from a plastic comprising an elastomer or a natural material such as rubber.

The wiper device can comprise a wiper arm adapter. The wiper arm adapter is preferably arranged on the wiper arm. The wiper device can comprise a wiper blade adapter. The wiper blade adapter is preferably arranged on the wiper blade. The wiper blade is preferably connected to the wiper arm via the wiper blade adapter and/or the wiper arm adapter.

The fluid connection element is intended to be connected to an element defining a fluid channel, such as a hose or a pipe, preferably by fitting the element defining the fluid channel onto an extension of the fluid connection element. Preferably, the fluid connection element is provided in particular for connecting the fluid supply line to a further fluid supply line and/or to a fluid-carrying component, such as in particular the wiper arm adapter and/or the wiper blade adapter. In particular, the fluid connection element forms a coupling element for the fluid supply line. The fluid connection element can be formed as part of a wiper arm adapter. The fluid connection element can be formed as part of a wiper blade adapter. The fluid connection element can be formed as part of an element formed separately from the wiper arm adapter and separately from the wiper blade adapter.

Preferably, the at least one fluid connection element forms a static portion of the at least one check valve. Preferably, the at least one fluid supply line forms an elastically deflectable section of the at least one check valve. Preferably, the at least one check valve is formed exclusively by the at least one fluid supply line and the at least one fluid connection element. Preferably, the at least one check valve is designed as a Dunlop valve.

By designing the wiper device according to the invention, an advantageously low-cost return valve can be achieved. In particular, an advantageous space-saving return valve can be achieved. In particular, a return valve that is advantageously easy to manufacture and/or install can be achieved. A return valve that is advantageously simple to equip with a heating element can be achieved. The wiper device can advantageously be assembled from existing component shapes, especially component designs. It can be achieved that the fluid supply line advantageously forms the function of the return valve itself.

It is further proposed that the at least one fluid connection element is at least partially formed as a fluid connection extension, which forms the at least one check valve, in particular Dunlop valve, with the at least one fluid supply line. Preferably, the at least one fluid connection element is at least partially formed as a fluid connection extension which extends over at least 1 cm, preferably over at least 1.5 cm, particularly preferably over at least 2 cm. The fluid connection element can be formed as a fluid connection extension on the wiper blade adapter and/or on the wiper arm adapter. The fluid connection element formed as a fluid connection extension preferably forms an extension of a further component or element and projects over at least 1 cm, preferably over at least 1.5 cm, particularly preferably over at least 2 cm, from a base body of the component or element on which the fluid connection element is arranged. Preferably, the at least one fluid connection element is materially connected, in particular integrally, to the wiper blade adapter, the wiper arm adapter and/or an element formed separately from the wiper blade adapter and the wiper arm adapter, such as for example glued, welded or produced directly in a casting. “Integrally” is understood as meaning connected at least by substance-to-substance bonding, for example by a welding process, an adhesive bonding process, a process of molding on and/or another process that appears expedient to the person skilled in the art, and/or advantageously formed in one piece, for example by production from a casting and/or by production in a single- or multi-component injection molding process and advantageously from a single blank. Advantageously simple assembly of the fluid feed unit, in particular the fluid supply line, on the fluid connection element can be achieved.

It is further proposed that the at least one fluid connection element define an angled fluid channel. Preferably, the fluid channel is angled 90°. Alternatively, the fluid channel can be angled 45°, 60°, 75°, 80° or 85°. Preferably, the fluid channel bounded by the at least one fluid connection element comprises a main fluid channel extending through the fluid connection element parallel to a longitudinal axis of the fluid connection element. Preferably, the fluid channel bounded by the at least one fluid connection element comprises at least one secondary fluid channel extending perpendicular to the main fluid channel. Preferably, the at least one secondary fluid channel is formed as an opening of the main fluid channel on one side of the fluid connection element. Preferably, the fluid supply line, which is designed in particular as a hose, is plugged onto the fluid connection element up to above the at least one secondary fluid channel. Preferably, the fluid supply line bounds the at least one secondary fluid channel in the direction of a transverse axis of the fluid connection element in an assembly condition. A “transverse axis” of an object preferably is to be understood as an axis which is perpendicular to a longitudinal axis of the object. Preferably, the at least one secondary fluid channel is arranged at one end of the fluid connection element. Preferably, the main fluid channel is fluidically sealed, in particular closed, in the direction of the longitudinal axis of the fluid connection element. Advantageous fluid pressure conditions to form a check valve can be achieved. In particular, it can be achieved that the fluid supply line can form an elastically deflectable part of a return valve.

It is further proposed that the at least one fluid supply line forms a flow-around region for the at least one fluid connection element by at least partially elastically deflecting in at least one operating condition. Preferably, the fluid supply line can be deflected elastically at least partially in the direction of the transverse axis of the fluid connection element. Preferably, the fluid supply line can be elastically deflected at least partially in the direction of a transverse axis of the fluid supply line, in particular perpendicular to a fluid conducting direction of the fluid supply line. Preferably, the at least one fluid supply line forms a flow around area for the at least one fluid connection element from an end of the fluid connection element to the secondary fluid channel by at least partially elastically deflecting in the operating condition. Preferably, the at least one fluid supply line is provided to be elastically deflected at a fluid pressure until the at least one fluid supply line forms a flow around area for the at least one fluid connection element up to the secondary fluid channel. Preferably, the at least one fluid connection element, in particular the main fluid channel and/or the secondary fluid channel, can be supplied with fluid by the elastic deflection of the fluid supply line. Advantageously, a fluid pressure-dependent fluid supply to the fluid connection element can be achieved.

It is further proposed that the wiper device comprises at least one heating element extending at least partially through the at least one fluid connection element. Preferably, the at least one heating element is formed at least partially and preferably for the most part as at least one heating wire, preferably with a thermally conductive sheath. Preferably, the at least one heating element extends along the longitudinal axis of the fluid connection element throughout the fluid connection element. Preferably, the at least one heating element extends at least partially along the longitudinal axis of the fluid supply line through the at least one fluid supply line, particularly at an end of the fluid supply line connected to the fluid connection element. An advantageously heatable and/or thawable return valve can be achieved. In particular, an advantageously heatable connection of the fluid supply line to the fluid connection element can be achieved.

It is further proposed that the fluid feed unit comprises at least one further fluid supply line, and the at least one fluid connection element is formed as a double-sided fluid connection extension which fluidically connects the fluid supply line and the further fluid supply line. Preferably, the further fluid supply line is at least partially and preferably for the most part a hose. Preferably, one end of each fluid connection element is connected to the fluid supply line or the further fluid supply line. Preferably, the at least one fluid supply line with the fluid connection element forms a check valve and/or the at least one further fluid supply line with the fluid connection element. Preferably, the fluid connection element is designed as an insert for integration into the fluid feed unit. Preferably, the at least one fluid connection element is designed as a fluid connection piece, in particular as a fluid I-piece, for two hoses of the fluid feed unit, in particular for the fluid supply line and the further fluid supply line. A return valve can be formed, which can advantageously be integrated into a fluid feed unit independent of location.

It is further proposed that the wiper device comprises at least one wiper arm adapter, in particular the aforementioned wiper arm adapter, which is spaced apart from the at least one fluid connection element. Preferably, the wiping arm adapter is arranged at one end of the wiping arm and/or connected to the wiping arm at the end of the wiping arm. Preferably, the fluid connection element is integrated into the fluid feed unit, in particular arranged between the fluid supply line and the further fluid supply line. An advantageous arrangement of the return valve independent of the wiper arm adapter can be achieved.

It is further proposed that the wiper device comprises at least one wiper blade adapter spaced from the at least one fluid connection element. An arrangement of the return valve that is advantageously independent of the wiper blade adapter can be achieved.

It is further proposed that the at least one fluid connection element is arranged in a proximal region of the wiper arm adapter. Preferably, the fluid connection element is integrated into the fluid feed unit in the vicinity of the wiper arm adapter, in particular arranged between the fluid supply line and the further fluid supply line. A “close range” of an object or an axis shall preferably be understood as an area around the object or the axis, which extends to a distance of maximum 10 cm, preferably maximum 5 cm, and especially preferably maximum 3 cm, to the object or the axis. An advantageously short fluid reaction time can be achieved.

Furthermore, a fluid connection element of a wiper device according to the invention is proposed.

Furthermore, a windshield wiper having a wiper device according to the invention is proposed.

The wiper device according to the invention, the fluid connection element according to the invention and/or the windshield wiper according to the invention are not intended to be limited here to the application and embodiment described above. In particular, the wiper device according to the invention, the fluid connection element according to the invention, and/or the windshield wiper according to the invention can/may have a number of individual elements, components, and units that differs from a number of individual elements, components, and units described herein in order to fulfill a mode of operation described herein. Moreover, for the ranges of values indicated in this disclosure, values lying within the aforementioned limits are also intended to be considered to be disclosed and usable as desired.

A recess can be formed between the end of the fluid supply line and the secondary fluid channel, which can be provided to improve sealing. The recess can extend annularly in the circumferential direction around the outer circumferential surface of the fluid connection element in the case of a tubular fluid connection element. It is preferably not interrupted.

In a particular embodiment, the sealing means is arranged externally on the region at the end of the fluid supply line so that the fluid supply line is clamped in between the sealing means and the fluid connection element. As a result, the fluid supply line is compressed inward and the resulting forces act radially inward on the line. The resulting pressure leads to a fluid-tight closure of the end of the line.

The sealing means can be arranged on the outer circumferential surface of the fluid supply line. In any case, the fluid supply line is elastically deformed and pressed onto the fluid connection element. If the recess is present, the sealing means is pressed into the recess with the line. The fluid supply line can be made of an elastomer.

In order to be able to ensure outward deformation, the sealing means should be arranged between the fluid connection element and the fluid supply line. In the process, the pipe expands outward, and the inward forces of the pipe press the sealing means onto the fluid connection element so that it fits tightly.

In another alternative, the sealing means can be arranged in the recess. In the process, the line presses the sealing means into the recess. This can be filled fluid-tight by the deformed sealing means.

The sealing means can be an O-ring. The sealing means can have a circular or angular cross-section. Alternatively, the sealing means can be integral with the fluid connection element. It can be made of the same material as the fluid connection element. The one-piece sealing means can be formed as a radially rising bead, preferably surrounding the connection element. It cannot be interrupted.

### BRIEF DESCRIPTION OF THE DRAWINGS

Further advantages follow from the following description of the drawings. The drawings illustrate two embodiment examples of the invention. The drawings, the description, and the claims contain numerous features in combination. A skilled person will appropriately also consider the features individually and combine them into additional advantageous combinations.

The following are shown:

FIGS. 1A and 1B are schematic sectional views of a fluid feed unit according the disclosure.

FIGS. 1C and 1D are schematic sectional views of an alternative fluid feed unit according to the disclosure.

### DETAILED DESCRIPTION

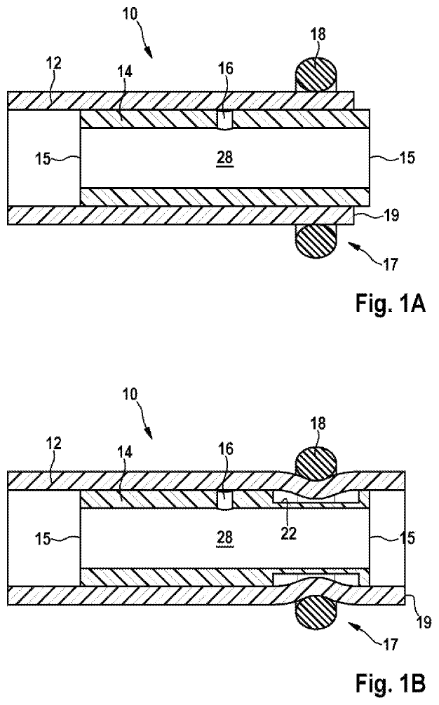

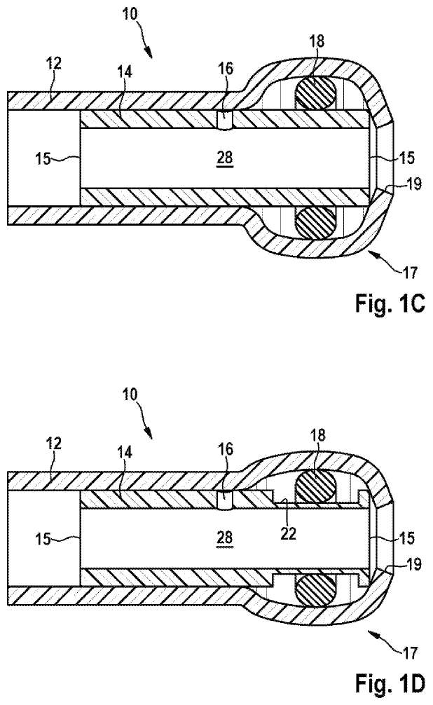

FIG. 1A shows a fluid feed unit 10 provided for a wiper device, which comprises a fluid supply line 12 and a fluid connection element 14. The fluid connection element 14 includes a main fluid channel 28 extending through the fluid connection element 14. The fluid connection element 14 can be tubular in shape and have two openings 15 associated with the main fluid channel 28. At least one opening 15 opens into the fluid supply line 12. The main fluid channel 28 is connected to at least one secondary fluid channel 16, which also opens into the fluid supply line 12. The secondary fluid channel 16 extends through a wall of the fluid connection element 14 and is oriented substantially transverse to the main fluid channel 28. The fluid supply line 12 rests on the opening of the secondary fluid channel 16 and seals it tightly. The fluid connection element 14 can protrude from the fluid supply line 12 at an end 19. A sealing means 18, which is particularly in the form of an O-ring, spring, cable tie, and/or clasp, cooperates with an area 17 at the end 19 of the fluid supply line 12, thereby sealing one of the openings 15 of the fluid supply line 12 and the secondary fluid channel 16 within the fluid supply line 12.

The sealing means 18 is arranged externally on the portion at the end 19 of the fluid supply line 12, such that the fluid supply line 12 is sandwiched between the sealing means 18 and the fluid connection element 14. The fluid supply line 12 and/or the sealing means 18 can include a resilient material. The sealing means 18 presses on the fluid supply line 12 and presses with a force, the material of the fluid supply line 12 against the outer peripheral surface of the fluid connection element 14. In the process, the material of the fluid supply line 12 can be stretched radially inward. The sealing means 18 is arranged between the end 19 and the secondary fluid channel 16. Area 17 also extends at least partially in this section.

A recess 22 is arranged between the end 19 of the fluid supply line 12 and the secondary fluid channel 16, as shown in FIG. 1B. The recess 22 is formed as a radially inwardly extending and circumferential depression. Furthermore, the recess 22 can be an annular groove that runs along the outer circumferential surface without interruption. The fluid supply line 12 is arranged on the recess 22 and preferably covers it completely. The sealing means 18 is arranged on the recess 22, wherein the fluid supply line 12 is arranged between the sealing means 18 and the fluid connection element 14. The sealing means 18 presses on the fluid supply line 12 and expands the wall of the fluid supply line 12 radially inward so that it projects into the recess 22. The recess 22 is at least partially filled by the material of the wall of the fluid supply line 12. Surfaces and/or edges of the recess 22 can be occupied by the wall of the fluid supply line 12, wherein the material of the wall is tightly sealed. This provides an additional seal.

In an alternative embodiment shown in FIG. 1C, the sealing means 18 is arranged between the fluid connection element 14 and the fluid supply line 12 so that the fluid supply line 12 is deformed outwardly. The force thereby acting radially inward, presses on the sealing means 18 and seals the end of the fluid supply line 12.

The sealing means 18 can be arranged directly in a recess 22, which is shown in FIG. 1D. The fluid supply line 12 can be arranged on the recess and sealing means 18. The sealing means 18 can be deformed so that it at least partially fills the recess 22 and presses on edges and surfaces of the recess 22.

In all embodiments, the sealing means 18 can alternatively be integrally formed with the fluid connection element 14. In this case, the sealing means 18 can be formed from the same material as the fluid connection element 14. The sealing means 22 can be formed as a radially rising bead.

### LIST OF REFERENCE NUMBERS

10 Fluid feed unit
12 Fluid supply line
14 Fluid connection element
15 Opening
16 Secondary fluid channel
18 Sealing means
19 End of line
22 Recess

1. A wiper device comprising at least one fluid feed unit (10) comprising a fluid supply line (12) and a fluid connection element (14), the fluid connection element (14) comprising a main fluid channel (28) opening into the fluid supply line (12) and connected to at least one secondary fluid channel (16) which also opens into the fluid supply line (12), wherein a sealing means (18) cooperates with a region at one end (19) of the fluid supply line (12) so that an opening (15) of the fluid supply line (12) and the secondary fluid channel (16) are sealingly arranged within the fluid supply line (12).

2. The wiper device according to claim 1, wherein a recess (22) is arranged between the end (19) of the fluid supply line (12) and the secondary fluid channel (16).

3. The wiper device according to claim 1, wherein the sealing means (18) is arranged externally on a portion at the end (19) of the fluid supply line (12), so that the fluid supply line (12) is clamped between the sealing means (18) and the fluid connection element (14).

4. The wiper device according claim 2, where the sealing means (18) deforms the fluid supply line (12) and presses it into the recess (22).

5. The wiper device according to claim 1, wherein the sealing means (18) is arranged between the fluid connection element (14) and the fluid supply line (12) so that the fluid supply line (12) is deformed outwardly.

6. The wiper device according to claim 2, wherein the sealing means (18) is arranged in the recess (22).

7. The wiper device according to claim 1, wherein the sealing means (18) is made integral with the fluid connection element (14).

8. The wiper device according to claim 7, wherein the sealing means (18) is formed as a radially rising bead.
